(19) United States
(12) Patent Application Publication
(10) Pub. No.: US 2014/0112700 A1
(43) Pub. Date: Apr. 24, 2014

(54) PROCESS FOR STRESS RELIEF OF THE STRESSES OF A PINNED END FITTING, STRESS-RELIEVED END FITTING OBTAINED

(71) Applicant: EPSILON COMPOSITE, Gaillan En Medoc (FR)

(72) Inventors: Noel CARRERE, Cestas Cedex (FR); Dominique NOGUES, Hourtin (FR)

(73) Assignee: EPSILON COMPOSITE, Gaillan En Medoc (FR)

(21) Appl. No.: 14/057,331

(22) Filed: Oct. 18, 2013

(30) Foreign Application Priority Data
Oct. 18, 2012 (FR) 1259922

(51) Int. Cl. F16C 11/04

(52) U.S. Cl. CPC F16C 11/045
USPC 403/41

(57) ABSTRACT

A process for relieving stresses in an end fitting (14) attached to a body (12) in the form of a longitudinal part such as a tube, with the end fitting including a yoke (18) with two arms (18-1, 18-2), each equipped with a hole (20-1, 20-2) designed to work with a pin (24), is characterized in that a removal of material upstream from each of the holes (20-1, 20-2) is carried out.

### FIELD OF THE INVENTION

This invention relates to a process for stress relief of a pinned end fitting, in particular of a longitudinal part such as a tube, more particularly a connecting rod in a structure with a static opening, of a frame, of an aircraft or of a ship. The invention also covers the stress-relieved end fitting that is thus obtained.

### BACKGROUND OF THE INVENTION

In any structure, individual elements that pull and/or push, such as connecting rods or tightening straps, are designed to take up major forces with maximum safety and minimum weight.

For example, in aeronautics and more particularly in the construction of aircraft, it is necessary to take up forces, and the structure is designed for this purpose.

The connection between the wings and the fuselage in particular is an area in which the absorption of forces is particularly complex.

For this purpose, a mesh of tie rods, also called connecting rods, which are subjected to compressive forces, tensile forces, and even buckling forces in an alternating way and with cycles that are extremely high in number, is provided.

These connecting rods are connected to other elements of the structure by yoke and pin mountings.

It is consequently understood that the pin connection is subjected to these same cycles.

These parts are subjected to major forces, and to varied stresses, and this is a very good example for illustrating this invention. This application is highly illustrative but in no way limiting.

In aeronautics, the drive to reduce weight is actually a constant because weight leads to an increased consumption of fuel or a loss of payload for the same consumption, which is detrimental in any case. In addition, aircraft manufacturers also seek to improve performances relative to the mechanical strength for the same weight, and even for a reduced weight.

Also, the connecting rods are made of materials that have the better mass/strength ratio such as the composite materials, and more particularly those based on carbon fibers.

In addition, by using a suitable resin, by resorting to the process for manufacturing by pultrusion, by adjusting the orientations of fibers and with enhanced manufacturing know-how, the body of connecting rods that are made exhibits extremely high mechanical characteristics with an extremely low weight.

The manufacturing of the “tubular part” of a connecting rod is industrialized, and the product that is obtained is adapted to aeronautical conditions.

At the level of the connection of these tubular products to the structure, the presence of a yoke located at the ends of said tubular part, as indicated above, has been adopted.

Furthermore, the end fitting attached to the connecting rod body is made from a light metal alloy such as titanium or aluminum by molding and/or machining. The yoke is factory-mounted with the body of the end fitting, which itself is designed to be encased and connected to the connecting rod body. The connection is preferably of the gluing type, but can also be achieved by screwing, riveting, welding, pinning or bolting, or any other known process.

The arms of the yoke each have a hole so as to receive the connecting pin.

A ring can be inserted between the inside walls of the hole and the pin, with said ring being mounted by clamping, for example, to immobilize it in the hole, but the process remains the same and is applied.

During the operation during which the pin and the yoke are subjected to major forces, these holes, because of the mounting with a pin, are subjected to concentrations of stresses in very limited areas of the mounting surfaces around the axis, and the alternating tensile forces and compressive forces lead to a premature fatigue.

This concentration of stresses in the immediate proximity of the holes is detrimental to the quality of the mechanical mounting and to the mechanical strength of the unit, in particular to its fatigue strength and to its static tensile strength.

This localized concentration of stresses can rapidly lead to incipient cracks and therefore, in the long run, to failure.

Because of the very strict safety rules that can be encountered in works of art, buildings, moving vehicles or, in the aeronautical field, such elements, integrated in the structure, are closely monitored vital parts.

In the case of a detection of such degradations, the element is changed, which affects at least the high maintenance costs, but in the case of an approximate monitoring, the risk of failure is not ruled out.

### SUMMARY OF THE INVENTION

This invention also, has the object of remedying this problem of crack initiation by concentrating stresses in a part that is subjected to repeated tensile/compressive stresses in a yoke/pin connection, in particular to limit the concentrations of stresses in the immediate proximity of the holes of the arms of the yokes.

This invention is now described in application to connecting rods of the structure of an aircraft, without this example being, in any manner, limiting.

### BRIEF DESCRIPTION OF THE DRAWINGS

The preferred embodiment based on the types of manufacturing is illustrative, and drawings are attached to explain this description, with the figures of these drawings showing:

FIG. 1: a perspective view of one end of an aeronautical connecting rod with an attached end fitting, being mounted by a pin, according to the invention,

FIG. 2: a lateral front view of a connecting rod of the prior art, with a diagrammatic representation of incipient cracks,

FIG. 3: a first lateral front view of the connecting rod of FIG. 1,

FIG. 4: A second cutaway view of the connecting rod of FIG. 3, following the trail of broken lines.

### DETAILED DESCRIPTION OF THE INVENTION

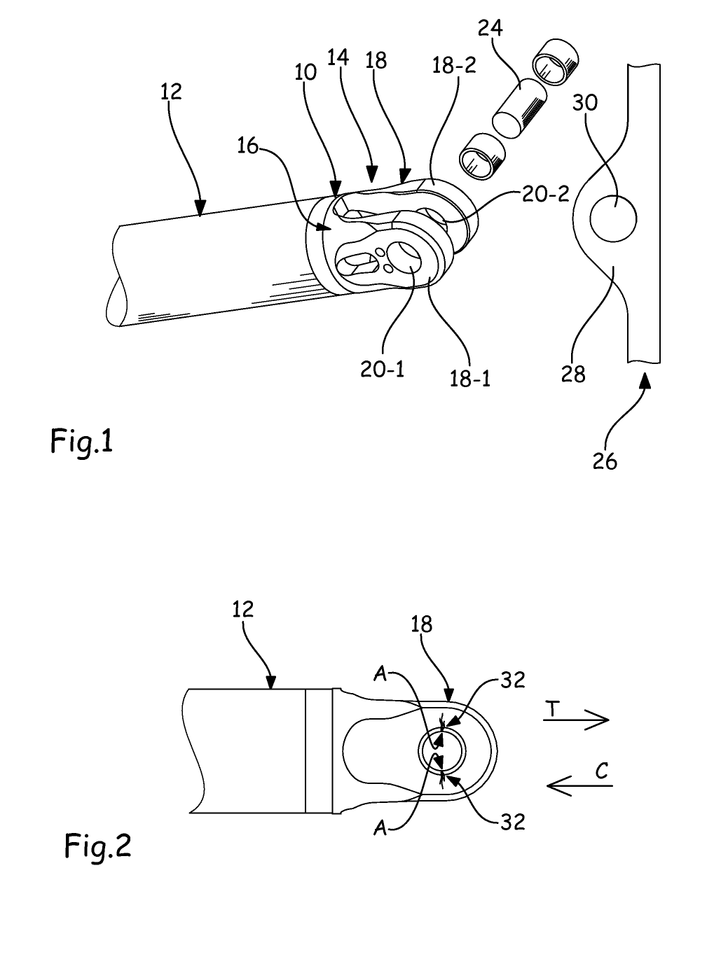

In FIG. 1, a tubular body is partially shown, in this case an aeronautical connecting rod 10 that consists of a connecting rod body 12 and two end fittings 14 attached to the ends of said body 12.

The tubular body 12 of the connecting rod is made of light and very strong materials, for example made of composite materials, in particular from high-module carbon fibers and epoxy resin fibers, with a process for manufacturing by pultrusion that makes it possible to obtain a connecting rod body of high precision and with elevated mechanical characteristics.

In this embodiment, the end fitting 14 is made of a metal material of the light alloy type such as aluminum. This end fitting 14 comprises an end fitting body 16 of a shape mated to that of the end of the body 12 of the connecting rod, in this case with a circular cross-section.

At the opposite end, the end fitting 14 has a yoke 18 with two arms 18-1, 18-2, each equipped with a hole 20-1, 20-2 designed to receive a pin 24 as will be explained later.

The free end of the connecting rod body 12 receives the end fitting 14 by encasing and gluing, with this connection not being part of this invention.

The connecting rod is thus designed for being connected to a structure 26 that is equipped with a handle 28 having a hole 30 designed also to receive the same pin 24 mentioned above. Said handle is housed between the two arms of the yoke.

In FIG. 2 of a connecting rod of the prior art, it is noted that when the connecting rod is subjected to tensile forces T and compressive forces C, a concentration of stresses—starting from the inside surface of the hole at least and an appearance of cracks 32 or at least an appearance of incipient cracks—occurs.

Mechanically, the presence of holes 20-1, 20-2 in the arms 18-1, 18-2 of a yoke 18 creates a stress concentration phenomenon at the edge of the hole and on the inside surface of the hole, whereas the stresses at the heart of the material of the arms 18-1, 18-2 and primarily in their part that is the farthest from the holes 20-1, 20-2 are much weaker.

This non-homogeneous distribution therefore causes stress concentration peaks, which are detrimental to fatigue life, the material around the most stressed area then being less stressed and therefore under-used.

The end area of the arm may seem to be weakly subjected to stresses, which is false because it ensures a bridging between the branches of each arm, and this bridging is essential for keeping the forces from concentrating at the top of the yoke.

Hereinafter, it is therefore considered that the end ensuring the bridging between the branches of each arm is of sufficient size to constitute a connection that is similar to a fitting.

If the representation of the stresses during the tensile forces that most stress the areas on the periphery of the hole is considered, it is noted that the stresses are concentrated in the area A, on each of the branches; see FIG. 2.

This highly localized concentration of stresses is the source of incipient cracks 32, and it is noted that when a failure occurs under failure load, the failure line propagates perpendicularly to the branches from the areas A, in the direction of the cracks shown in FIG. 2.

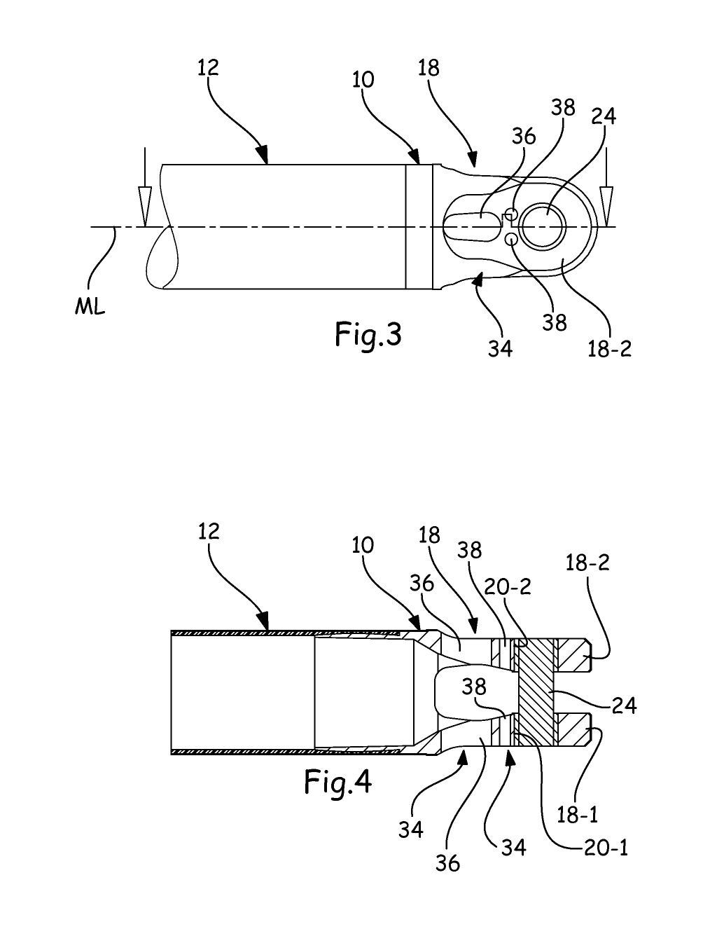

The process according to this invention therefore consists in creating relief of the localized stresses so as to better distribute them and to stress the material surrounding the hole in an expanded manner; see FIGS. 3 and 4.

This process consists in carrying out a removal of material 34 upstream from the hole of each arm 18-1, 18-2 of the yoke.

In this case, the removal of the material 34 consists in creating at least one slot 36 along the longitudinal median axis ML of said arm, upstream from the hole. Preferably, this at least one slot 36 is essentially circular or oblong in shape.

This at least one slot 36 is to be located close to the hole because the closer it is to the hole 20, the better the distribution of tensile stresses.

A stress relief of the stresses is then noted when the end fitting undergoes tensile forces.

It is then recalled that said yoke 18 is also subjected to compressive forces although it is necessary to use sufficient material between the hole 20 of the yoke and said slot 36 to withstand these compressive forces. This can be determined easily by one skilled in the art, in particular by calculation.

A reduction in the maximum stresses by stress channeling thanks to the presence of this slot is therefore achieved.

Nevertheless, calculations and tests show that if the at least one slot 36 is moved away from the hole 20 to obtain a bridge that is sufficient for compression strength, the bridge between this slot and this hole constitutes a rigid connection that is still too large so that the stresses in the hole are not relieved and distributed sufficiently.

According to the process of this invention, in the case where the forces are of alternating tensile/compressive type, two additional openings 38 are located between the hole 20 and the oblong slot 36, positioned in an offset manner relative to the longitudinal median axis ML of the arm, on both sides of this axis.

These additional openings 38 are arranged upstream from the hole 20 and downstream from the slot 36.

According to the tests conducted and the calculations carried out on a product that is to be industrialized, including not only fatigue stresses but also fretting phenomena, it is possible to note that the maximum stress in the critical fatigue area decreased from a value of 177 MPa to 165 MPa.

If this reduction may seem to be low, it is reflected by a very significant increase in the number of life cycles: thanks to the process according to this invention, the operation rises from 650,000 cycles to 10⁶ cycles or close to a 54% increase.

If corrective coefficients are applied because of surface treatments carried out on the inside surfaces of the holes 20 and on the peripheral surface of the pin 24, it is possible to estimate the correction at +17%; maximum values of shear stress are obtained at 207 MPa, and the presence of the slot and openings reduces the maximum stress to 195 MPa, with this reduction leading to a gain in service life of 35%, rising from 340,000 cycles to 460,000 cycles.

If a ring is inserted into the hole 20, even if the ring transfers the stresses to a larger surface, the clamping of this ring generates a superposition of approximately an additional 30 MPa of simple tensile stresses.

In this case, by using the process according to this invention, the maximum stress goes from 237 MPa to 225 MPa, which represents a gain in service life of 31%, with the number of cycles rising from 175,000 to 230,000.

It is therefore noted that the presence of the oblong slot and openings make it possible for the at least one gain in service life of 31%, which is considerable for aeronautical maintenance since this is the field of application that is adopted.

The invention also covers the end fitting 14 that is obtained by the implementation of the process that was just described, attached to a connecting rod body 12, with said end fitting 14 comprising a yoke 18 with two arms 18-1, 18-2, each equipped with a hole 20-1, 20-2 designed to work with a pin 24, and comprising a removal 34 of material upstream from each hole 20.

Preferably, the end fitting 14 is made of metal.

This invention therefore finds a major advantage in this particular aeronautical application that has numerous specific stresses, but the process can be applied to any field where tie rods with attached or factory-mounted end fittings are highly stressed.

It is also noted that even if this is not the primary objective sought in this invention, the arrangement of slots and openings makes it possible to increase weight, always significant in aeronautics.

Thus, the invention makes possible not only a significant gain in strength on the order of 5 to 10%, a gain in service life on the order of 31 to 54%, but also a very substantial gain in the mass/strength ratio or mass/service life ratio.

Such yoke end fittings mounted with a pin can be applied in numerous fields so as to relieve highly localized stresses.

1. Process for relieving stresses in an end fitting (14) attached to a body (12) in the form of a longitudinal part such as a tube, with said end fitting comprising a yoke (18) with two arms (18-1, 18-2), each equipped with a hole (20-1, 20-2) designed to work with a pin (24), characterized in that a removal (34) of material is carried out upstream from each of said holes (20-1, 20-2).

2. Process for relieving stresses in an end fitting (14) attached to a body (12) according to claim 1, wherein by way of removal (34) of material, at least one slot (36) is made.

3. Process for relieving stresses in an end fitting (14) attached to a body (12) according to claim 2, wherein by way of removal (34) of material, at least one slot (36) that is essentially oblong in shape is made.

4. Process for relieving stresses in an end fitting (14) attached to a body (12) according to claim 2, wherein the slot (36) is made along the longitudinal median axis (ML) of said arm.

5. Process for relieving stresses in an end fitting (14) attached to a body (12) according to claim 2, wherein by way of removal of material, in addition to the at least one slot (36), openings (38) inserted upstream from the hole (20) and downstream from said at least one slot (36) are made.

6. Process for relieving stresses in an end fitting (14) attached to a body (12) according to claim 5, wherein the two additional openings (38) located between the hole (20) and the slot (36) are positioned in an offset manner relative to the longitudinal median axis (ML) of the arm, on both sides of this axis.

7. End fitting (14) of an aeronautical connecting rod (10), attached to a connecting rod body (12), with said end fitting comprising a yoke (18) with two arms (18-1, 18-2), each equipped with a hole (20-1, 20-2) designed to work with a pin (24), wherein it comprises a removal (34) of material upstream from each hole (20).

8. End fitting (14) of an aeronautical connecting rod (10) according to claim 7, wherein the end fitting (14) is made of metal.

9. Process for relieving stresses in an end fitting (14) attached to a body (12) according to claim 3, wherein the slot (36) is made along the longitudinal median axis (ML) of said arm.

10. Process for relieving stresses in an end fitting (14) attached to a body (12) according to claim 3, wherein by way of removal of material, in addition to the at least one slot (36), openings (38) inserted upstream from the hole (20) and downstream from said at least one slot (36) are made.

11. Process for relieving stresses in an end fitting (14) attached to a body (12) according to claim 4, wherein by way of removal of material, in addition to the at least one slot (36), openings (38) inserted upstream from the hole (20) and downstream from said at least one slot (36) are made.
